(19) United States
(12) Patent Application Publication
(10) Pub. No.: US 2015/0122384 A1
(43) Pub. Date: May 7, 2015

(54) Synthetic Fiber Lined Tire

(71) Applicant: Cecil Dilworth, Nettleton, MS (US)

(72) Inventor: Cecil Dilworth, Nettleton, MS (US)

(21) Appl. No.: 14/534,969

(22) Filed: Nov. 6, 2014

Related U.S. Application Data
(60) Provisional application No. 61/901,325, filed on Nov. 7, 2013.

(51) Int. Cl. B60C 5/14; B60C 11/12; B60C 9/00; B60C 15/06; B60C 9/02; B60C 11/13; B60C 9/18

(52) U.S. Cl. CPC B60C 5/14; B60C 11/13; B60C 11/12; B60C 9/18; B60C 15/06; B60C 9/02; B60C 9/0042
USPC 152/209.18; 152/510

(57) ABSTRACT

The present invention provides a tire with a synthetic fiber interior layer that adds flexibility and resistance to punctures from sharp objects. The present invention includes a rubber layer having an interior and exterior surface forming a substantially U-shaped tire cross section. Embedded between the interior and exterior surface of the rubber layer are radial plies extending across the tread, shoulders and sidewalls of the exterior surface. Sidewalls further include inner ends, wherein each radial ply folds back onto itself to form an enclosed bead chaffer region. An interior layer is coextensively and interiorly disposed along the radial ply. The interior layer is disposed within the tire cross section around the beads, and exits the tire cross section through the interior surface of the rubber layer and into the open interior of the tire. The interior layer is separable and freely positioned against the interior surface of the rubber layer.

### CROSS REFERENCE TO RELATED APPLICATION

This application claims the benefit of U.S. Provisional Application No. 61/901,325 filed on Nov. 7, 2013. The above identified patent application is herein incorporated by reference in its entirety to provide continuity of disclosure.

### BACKGROUND OF THE INVENTION

### Field of the Invention

The present invention relates to automobile tires. More specifically, the present invention pertains to an improved tire that includes an interior layer that improves the durability and resistance to punctures. The interior layer is disposed within the tire cross section around the beads, and exits the tire cross section through the interior surface of the rubber layer and into the open interior of the tire. The interior layer is separable from and freely positioned against the interior surface of the rubber layer and allows the tire to maintain its structural integrity despite a sharp object penetrating through the rubber layer.

Vehicles are perceived as a symbol of freedom and a way to achieve personal independence. Vehicles take people places they wouldn't otherwise be able to travel, brings people to destinations faster, and allows people to be self-reliant. However, as enjoyable as the freedom a car can provide, this freedom can quickly vanish when a flat tire strands a vehicle driver and their passengers. A flat tire can be frustrating as it can be the cause of tardiness to a date, appointment or meeting. Changing a flat tire in the rain, after dark, or on the shoulder of a busy highway is also a venture that can be frightening and dangerous. A common hazard while changing a flat tire is passing traffic. If the driver is only able to pull over to the side of the road and cannot reach a safe area away from traffic, the driver is at risk of being hit if the tire needing to be changed is on the side closer to traffic. If the driver is unable to pull over, a driver may not be able to tend to their vehicle and traffic congestion or worse, traffic collisions, may result.

The most common cause of a flat tire is puncturing by a sharp object, such as a nail or similar object that punctures and allows air to escape. Depending on the size of the puncture, the tire may deflate slowly or rapidly. Other causes of tire deflation include: failure of or damage to the valve stem; vandalism, such as intentionally puncturing or allowing air to escape from the valve; rubbing of the tire against the road; tire failure; separation of tire and rim by collision with another object; and excessive wear of the tire tread allowing road debris to compromise its carcass. The best prevention method to avoid a flat tire is to avoid situations in which tire punctures from road debris are likely. These include, and are not limited to, driving through areas with heavy construction activity, and driving through roads with rough surfaces, such as debris, gravel, or uneven pavement. However, driving through these areas is sometimes inevitable and unavoidable. Therefore, there exists a need for a tire with stronger resistance to puncture by sharp objects.

The present invention provides a tire with a synthetic fiber interior layer that adds flexibility and resistance to punctures from sharp objects. The present invention includes a tire with a rubber layer having an interior and exterior surface forming a substantially U-shaped tire cross section. Embedded between the interior and exterior surface of the rubber layer are radial plies extending across the tread, shoulders and sidewalls of the exterior surface. Sidewalls further include inner ends, wherein each radial ply folds back onto itself to form an enclosed bead chaffer region. An interior layer is coextensively and interiorly disposed along the radial ply around the bead chaffer region. The interior layer is split from the radial plies facing the open interior of the tire and exits the tire cross section through the interior surface of the rubber layer and into the open interior of the time. When a tire is inflated, the interior layer is pressed against the interior surface of the rubber layer, but remains separable from and freely positioned against the interior surface of the rubber layer.

### DESCRIPTION OF THE PRIOR ART

Devices have been disclosed in the prior art that tires and tire inner liners. These include devices that have been patented and published in patent application publications. Some of these devices disclose belt layers on tires, while other devices disclose a tire inner liner using a copolymer or a mixture of a polyamide-based resin and a polyether-based resin. These devices, however, do not disclose an interior layer that is disposed within the tire cross section around the beads, and exits the tire cross section through the interior surface of the rubber layer and into the open interior of the tire. The foregoing is a list of devices deemed most relevant to the present disclosure, which are herein described for the purposes of highlighting and differentiating the unique aspects of the present invention, and further highlighting the drawbacks existing in the prior art.

Specifically, Published U.S. Patent Application Number 2013/0101821 to Jeon discloses a film for a tire inner liner having a base film composed of a copolymer or mixture of a polyimide-based resin and a polyether-based resin. The Jeon device further discloses an adhesive layer including a resorcinol-formalin-latex-based adhesive used to bond the film to the tire carcass layer, and a method for manufacturing the same. However, the foregoing Jeon device discloses a tire inner liner that is embedded within the tire carcass layer, and not an interior layer that is inflated and pressed against the interior of the tire.

Similarly, U.S. Published Patent Application Number 2002/0074068 to Howland discloses fabric-based inserts and layers for use with tires adapted to provide an improved level of puncture resistance to the tire. The Howland device discloses tire anti-puncture layers including puncture-resistant layers that have one or a plurality of layers of fabric. The puncture-resistant layers are composed of fibers having a certain tensile strength and cover factor. In some embodiments, the Howland device is a separable strip that can be placed within a tire to act as a liner. In other embodiments, the foregoing device is incorporated within the cross-section of the tire body itself. However, the foregoing Howland device discloses an interior layer that is incorporated into the tire carcass or adhesively attached to the interior and not one that is inflated and pressed against the interior of the tire.

U.S. Pat. No. 7,337,817 to Takagi relates to a radial tire having belt cords of a belt layer which are arranged to be spirally wound almost in parallel with a tire circumferential direction. The Takagi device discloses a belt layer having a plurality of belt cords spirally and circumferentially wound on the outer circumference of a body ply. However, the Takagi device does not relate to a tire inner liner, specifically an interior layer that is inflated and pressed against the open interior of the tire.

U.S. Pat. No. 4,262,724 to Sarkissian is directed to a run-flat insert which permits a deflated tire to remain in operation at limited speeds for limited distance. The Sarkissian device discloses a pneumatic insert configured to warn a driver of a deflated or low pressure condition in the tires of a vehicle in operation. The pneumatic insert is mounted on a standard rim for positioning within a tire cavity. The insert can be formed as a generally toroidal-shaped hollow member having a pair of axially spaced apart insert beads arranged to bear against the tire beads and the rim. The Sarkissian device does not relate to a tire inner liner.

Published U.S. Patent Number 2007/0095450 to Yoshimi discloses a side-reinforced run flat tire adapted to run a predetermined distance even if an internal pressure thereof drops to a range of 50 to 150 kPa, due to puncture and so forth. The device discloses a pneumatic radial tire having a tread, sidewalls extending inward from respective ends of the tread, and a belt-reinforcing layer. The belt-reinforcing layer is composed of composite cord formed by twisting a high-modulus fiber and a low-modulus fiber together. However, the foregoing Yoshimi device does not disclose an interior layer that is neither adhesively attached to the interior of the tire nor embedded within the tire carcass, but is inflated and pressed against the interior of the tire.

The devices disclosed in the prior art have several known drawbacks. These devices are limited to tire inner liners that are disposed within the tire carcass layer or as a separable layer within the interior of the tire. The present invention overcomes these limitations by disclosing an interior layer that is disposed within the tire cross section around the beads, and exits the tire cross section through the interior surface of the rubber layer and into the open interior of the tire.

The interior layer is coextensively and interiorly disposed against the radial ply around the beads. The interior layer is separable from and freely positioned against the interior surface of the rubber layer opposite of the tread, shoulders and a significant portion of the sidewalls. The interior layer is pressed against the tire interior surface by the inflation pressure, but freely separates therefrom in the event of a puncture from a nail or other road debris that compromises the tread of the tire. It is therefore submitted that the present invention is substantially divergent in design elements from the prior art, and consequently it is clear that there is a need in the art for an improvement to tires and tire inner liners. In this regard, the instant invention substantially fulfills these needs.

### SUMMARY OF THE INVENTION

In view of the foregoing disadvantages inherent in the known types of tires and tire liners now present in the prior art, the present invention provides a new and improved synthetic fiber lined tire including an interior layer utilized to add durability, longevity, and resistance to punctures and leaks.

It is therefore an object of the invention to provide a new and improved synthetic fiber lined tire that has all of the advantages of the prior art and none of the disadvantages.

Still yet another object of the present invention is to provide a new and improved synthetic fiber lined tire that comprises an interior layer disposed coextensively and interiorly along the radial ply.

A further object of the present invention is to provide a new and improved synthetic fiber lined tire wherein the interior layer is disposed within the tire cross section around the beads and exits the tire cross section through the interior surface of the rubber layer and into the open interior of the tire.

Another object of the present invention is to provide a new and improved synthetic fiber lined tire wherein the interior layer is separable from and freely positioned against the interior surface of the rubber layer.

Yet a further object of the present invention is to provide a new and improved synthetic fiber lined tire wherein the interior layer is added to provide flexibility and resistance to punctures from sharp objects.

Yet another object of the present invention is to provide a new and improved synthetic fiber lined tire wherein the interior layer is also added to prevent the occurrence of a flat tire.

Still yet another object of the present invention is to provide a new and improved synthetic fiber lined tire wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a sectional view of the preferred embodiment of the present invention.

FIG. 2 shows a sectional view of the tire tread with a nail penetrating the tread on the exterior surface of the tire.

FIG. 3 shows a side perspective of the preferred embodiment of the present invention as removably mounted on a wheel.

### DETAILED DESCRIPTION OF THE INVENTION

References are made herein to the attached drawings. Like reference numerals are used throughout the drawings to depict like or similar elements of the synthetic fiber lined tire. For the purposes of presenting a brief and clear description of the present invention, the preferred embodiment will be discussed as removably mounted on a wheel. The figures are intended for representative purposes only and should not be considered to be limiting in any respect.

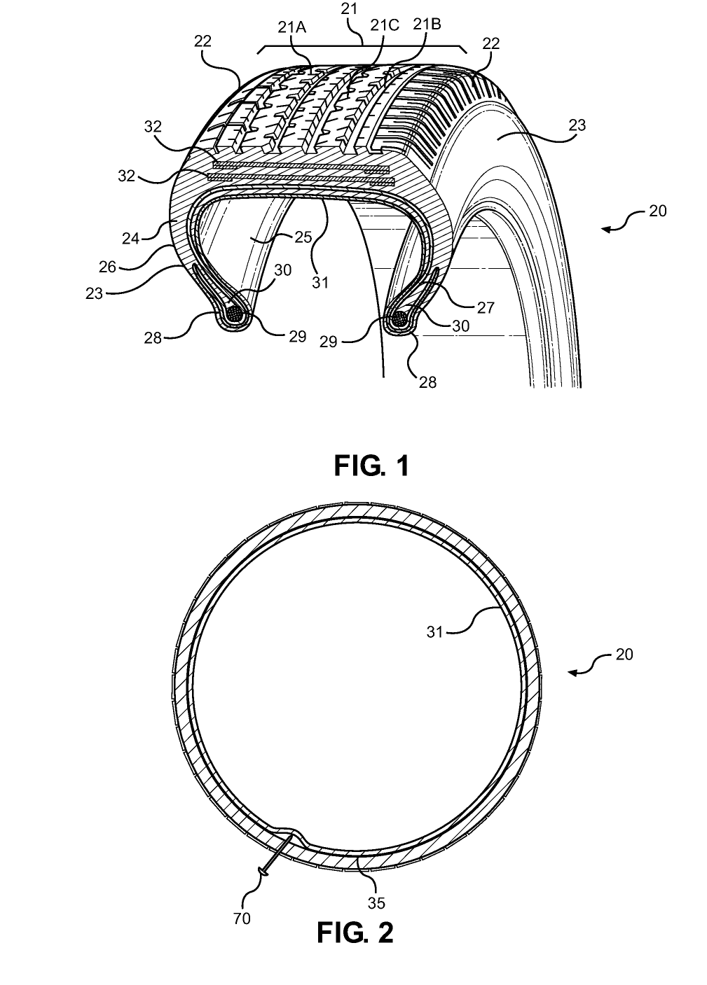

Referring now to FIG. 1, there is shown a sectional view of tire 20 in its preferred embodiment. The tire 20 is substantially donut-shaped and comprises a rubber layer 24 having an interior and exterior surface 25, 26. The tire cross section comprises a tread 21, a pair of shoulders 22, and sidewalls 23 extending inwardly from the tread 21 to form a substantially U-shape. Embedded between the interior and exterior surface 25, 26 of the rubber layer 24 are radial plies 27 that extend across tread 21, over the shoulders 22 and down the sidewalls 23. Sidewalls 23 further comprise inner ends 28, wherein each radial ply 27 folds back onto itself to form an enclosed bead chaffer region 30. Beads 29 are positioned within the bead chaffer region 30 of each sidewall inner end 28.

The tire 20 further comprises an interior layer 31 coextensively and interiorly disposed along the radial ply 27. The interior layer 31 is disposed within the tire cross section around the beads 29, and exits the tire cross section through the interior surface 25 of the rubber layer 24 and into the open interior of the tire. Thus, the interior layer 31 is disposed within the open portion of the tire cross section and is freely positioned against the interior surface 25 of the rubber layer 24.

The interior layer 31 and radial plies 27 are flush and positioned on top of one another around the bead chaffer region 30. The interior layer 31 exits the tire cross section through the rubber layer 24 and into the open interior of the tire. In this portion, the radial plies 27 bifurcate from the interior layer 31, as radial plies 27 are uniformly embedded within the tire cross section across the sidewalls 23, shoulders 22, and tread region 21 of the tire 20. The interior layer 31 is freely positioned within the open interior of the tire 20 along a significant portion of the sidewalls 23 and along the entirety of the shoulders 22 and the tread 21. Although the interior layer 31 facing the open interior of the tire is freely positioned and not embedded within the tire cross section, the interior layer 31 is still substantially parallel to the radial plies 31 and tire cross section, as the tire pressure inflates the tire and presses the interior layer 31 against the interior surface 25 of the tire under normal conditions.

Those skilled in the art will recognize, or be able to ascertain using no more than routine experimentation, the exit point of interior layer 31 through the rubber layer 24 occurs between the sidewall inner ends 28 and the tread portion 21. Those of ordinary skill in the art will also readily envision a variety of other locations within this range, or substantially equivalent thereto, in which the interior layer 31 exits the tire inner layer. It is not desired to limit the exact point of exit of the inner layer 31 from the tire interior surface. Rather it is desired to disclose and claim a functional inner layer 31 that is freely positioned within the tire for obtaining the results and the advantages described herein. These modifications and variations are deemed to be within the scope of the inventive embodiments described herein.

In this manner, interior layer 31 is attached only around the sidewall inner ends 28, specifically around the bead chaffer regions 30. The interior layer 31 structure is particularly advantageous in use, as it allows separation of the interior layer 31 with respect to the tire interior surface, allow significant flexibility and give if a sharp object penetrates through the tire 20. Despite a sharp object penetrating through the rubber layer 24, the interior layer 31 is able to maintain the structural integrity of the tire and prevent a flat tire. The interior layer 31 is inflated with the tire pressure and can maintain the pressure in the tire 20 in the event the tread 21 of the tire 20 is punctured. The interior layer 31 can deform readily and is comprised of a resilient material, therefore resisting puncture even if the tire tread 21 has been punctured. Therefore, the tire 20 with the interior layer 31 provides stronger resistance and durability.

The tread 21 functions as the part of the tire 20 that comes in contact with the road surface; it is needed to provide traction and handling, to channel away water, and to prevent hydroplaning. Shoulder 22 is the area of tire 20 at the edge of tread 21 as it transitions to the sidewall 23. The sidewall 23 is the area of the tire 20 that bridges between the shoulder 22 and beads. The tread 21 further comprises a plurality of grooves 21A, lugs 21B, and voids 21C. The grooves 21A are substantially indentations adapted to run circumferentially around the tire between a plurality of adjacent tread lugs 21B. The lugs 21B are the raised portions that have substantially a zig-zag pattern circumferentially around tire 20. The voids 21C are substantially small cuts in the tread lugs 21B. In other embodiments, tread area 21 are radially arranged or have a different aesthetic design based on tire purpose and type.

Inner ends 28 are adapted to function as the area that meets the rim or outer edge of a wheel. The beads 29 include steel wire adapted to reinforce the inner ends 28. In other embodiments, other suitable materials compose of the beads. As illustrated in FIG. 2, the inner ends 28 sit tightly against the rim or the wheel to ensure that tire 20 holds air without leakage. Inner ends 28 fit tightly around the rim to ensure that the tire 20 does not shift circumferentially as the wheel rotates.

Embedded between the interior and exterior surface of the rubber layer are radial plies 27 and belt plies 35. Radial plies 27 and belt plies 35 are designed to hold the shape of the rubber layer to prevent any stretching in response to internal pressure and provide for a smooth ride. The radial plies 27 are radial in nature and run perpendicularly to the direction of rotation of tire 20. The radial plies 27 constitute the basic skeletal structure of tire 20. Radial plies 27 comprise sheets having polyester cords that are wound together to form sheets. In other embodiments, radial plies 27 are composed of any other suitable fiber cords wound together and sandwiched in the rubber layer.

Belt plies 35 run circumferentially around the tire 20. Belt plies 35 comprise steel rectangular sheets with steel cords woven together to form large sheets of braided steel. Belt plies 35 are also sandwiched together between the exterior and interior surface of the rubber layer. In other embodiments, tire 20 may further comprise cap plies that are sheets similar to the belt plies 35 except that the cap plies are composed of woven fibers, such as nylon.

Referring now to FIG. 2, there is shown a sectional view of the tire tread 21. When the tire 20 is inflated and mounted on a vehicle, interior layer 31 is inflated and flush against the interior surface 25 of rubber layer 24. The pressurized air within the tire 20 presses the interior layer 31 against the rubber layer 24. The interior layer 31 is able to maintain the structural integrity of the tire 20 if a sharp object such as nail 70 was to penetrate the rubber layer 24. Because of its flexible and durable nature, it allows the interior layer 31 to be separable and bend without rupturing, despite a nail 70 piercing through rubber layer 24, which in most conventional cases would cause a flat tire.

The interior layer 31 is composed of a para-aramid (Kevlar or equivalent) synthetic fiber which provides the flexibility and durability of the interior layer and allows for the interior layer 31 to give but not rupture despite a sharp object, such as a nail 70, penetrating through rubber layer 24. Although interior layer 31 is composed of a flexible synthetic fiber, the interior layer 31 is still designed to be an impermeable layer which creates an airtight chamber when fitted to a wheel. Other embodiments are composed of other suitable aramid synthetic fibers for interior layer 31.

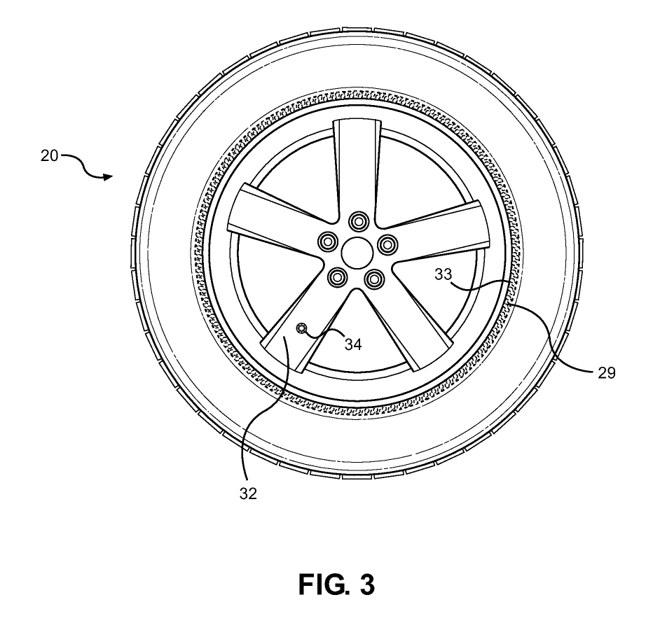

Referring now to FIG. 3, the tire 20 is removably mounted onto wheel 32. Wheel 32 is cylindrical in shape having a first circular base and a second circular base integrally attached on opposite ends of a channel. The first base and the second base further comprise a rim 33 that is substantially a protruding outer edge around the perimeter of first and second circular base. The tire 20 is removably mounted thereon wheel 32 by forcing beads 27 into the channel formed by the rims 32. Beads 29 of the tire 20 secure the rim 33 of a wheel 32 in an airtight fit around wheel 32. The wheel 32 further comprises a valve 34 that allows for the tire 20 to be inflated. As the tire 20 is inflated, the interior layer is pressed against the interior surface of the rubber layer to provide an additional layer of rupture protection. Other embodiments of tire 20 are larger and smaller and adapted to align with different sizes and shapes of the wheels 32 and rims 33.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A pneumatic tire having a separable interior layer to resist puncture and pressure loss, comprising:
a tread and a pair of shoulders and sidewalls extending inward from the tread to form a substantially U-shaped tire cross section;
each of said sidewalls having a sidewall inner end;
a radial ply extending within said tire cross section and across said tread and said pair of shoulders and sidewalls;
said radial ply folding back onto itself at each sidewall inner end to form an enclosed bead chaffer region;
beads positioned within the bead chaffer regions of each sidewall inner end;
an interior layer of synthetic material coextensively disposed over said radial ply;
said interior layer disposed interiorly with respect to said radial play within said tire cross section;
a rubber layer over said radial ply and disposed along an interior surface and an exterior surface of said tread and said pair of sidewalls;
said interior layer disposed through said rubber layer along an interior surface of said rubber layer;
said interior layer disposed within said tire cross section and freely positioned against said interior surface of said rubber layer;
said interior layer configured to be plush against said interior surface of said rubber layer when said pneumatic tire is inflated.

2. The pneumatic tire of claim 1, wherein:
said inner layer is separable from said interior surface of said rubber layer when a foreign object punctures said rubber layer.

3. The pneumatic tire of claim 1, wherein:
said tread comprises a plurality of grooves, lugs and voids.
said grooves comprising indentations that run circumferentially around said tread between a plurality of adjacent tread lugs;
said lugs comprise raised portions that have substantially a zig-zag pattern circumferentially around said tread;
said voids comprise small cuts in in said tread lugs.

4. The pneumatic tire of claim 1, wherein:
said interior layer is composed of para-aramid synthetic fiber.

5. The pneumatic tire of claim 1, wherein:
said radial plies comprise sheets having polyester cords that are wound together to form sheets.

6. The pneumatic tire of claim 1, further comprising belt plies and cap plies within said tire cross section and circumferentially across said tread.

7. The pneumatic tire of claim 6, wherein:
said belt plies comprise steel rectangular sheets with steel cords woven together to form large sheets of braided steel.

8. The pneumatic tire of claim 6, wherein:
said cap plies comprise fiber sheets with fiber cords woven together to form large sheets of woven fiber.
